(19) United States
(12) Patent Application Publication
(10) Pub. No.: US 2015/0169814 A1
(43) Pub. Date: Jun. 18, 2015

(54) HARMONIC DISTORTION MACRO MODEL CORRECTION USING A MEMORY TABLE

(71) Applicant: TEXAS INSTRUMENTS INCORPORATED, Dallas, TX (US)

(72) Inventors: HERMAN THEODORUS, DALLAS, TX (US); MARCOS L. LOPEZ, ADDISON, TX (US); JOHN E. MILLER, PLANO, TX (US); ARASH LOLOEE, ALLEN, TX (US)

(21) Appl. No.: 14/574,481

(22) Filed: Dec. 18, 2014

Related U.S. Application Data
(60) Provisional application No. 61/917,575, filed on Dec. 18, 2013.

(51) Int. Cl. G06F 17/50

(52) U.S. Cl. CPC G06F 17/5036

(57) ABSTRACT

A method of harmonic distortion (HD) macro-model error correction uses a HD simulation macro-model for an electronic device and memory table storing an operating condition/variable that affects HD and HD coefficient value(s). A processor runs the macro-model using information in the memory table for generating HD simulation values. The memory table is initially filled with a first condition/variable and initial HD coefficient. The processor runs the simulation macro-model for generating an initial HD simulation value. An initial Datasheet to initial HD simulation error (D-S error) is determined. Provided the magnitude of D-S error is above a predetermined error bound (PEB), an updated HD coefficient is used for repeating the filling, generating an updated HD simulation value and determining D-S error to obtain a corrected HD coefficient(s) which reduces the D-S error<PEB. The corrected HD coefficient(s) is stored in the memory table to update the simulation macro-model.

### CROSS REFERENCE TO RELATED APPLICATIONS

This application claims the benefit of Provisional Application Ser. No. 61/917,575 entitled “Harmonic Distortion Macro Model Correction Method that is universal, easy-to-use and accurate” filed Dec. 18, 2013 and provisional application No. 61/917,585 entitled “Harmonic Distortion vs. Loading macro modeling” also filed on Dec. 18, 2013, which are both herein incorporated by reference in their entireties.

### FIELD

Disclosed embodiments relate to harmonic distortion macro-models for simulating electronic circuits.

### BACKGROUND

Circuit designers need macro-models that can precisely and accurately predict the behavior of an actual electronic device in their particular application to avoid the need to build breadboards for actual testing. Circuit simulation programs, of which Simulation Program with Integrated Circuit Emphasis (SPICE) and derivatives are the most often used, take a text netlist describing the circuit elements (transistors, resistors, capacitors, etc.) and their connections, and translate this description into equations to be solved. The general equations produced are nonlinear differential algebraic equations which are solved using implicit integration methods, Newton's method and sparse matrix techniques.

SPICE macro-models have evolved over the past decade, and new models allow users to duplicate characterization data on their computers. Unfortunately, most electronic circuit simulation models that claim to provide circuit designers with accurate simulation data actually do not duplicate the actual behavior of the device, at least for certain parameters, and some available SPICE models also still lack certain parameters. For example, most available simulation models do not adequately simulate noise or distortion, generally providing erroneous and misleading readings even for relatively simple circuits such as low-noise precision operational amplifiers. As known in the art, “noise” describes the random electrical signals produced by the device, while “distortion” refers to unwanted harmonics introduced by the device.

### SUMMARY

This Summary briefly indicates the nature and substance of this Disclosure. It is submitted with the understanding that it will not be used to interpret or limit the scope or meaning of the claims.

Disclosed embodiments recognize there are no known macro-modeling solutions for fixing the simulated HD error relative to an electronic device's datasheet for harmonic distortion (HD) (D-S error) which provide universality so that the solution can be applied across the boundary of different circuit architectures, ease-of-use, and accuracy (e.g., D-S error<1 dB error). Ease-of-use refers to the solution can generally be used by any macro-model engineer without requiring the macro-model engineer to possess a thorough understanding of the circuit architecture (or years of experience), significant time (e.g., several weeks) to do trial and error work, and ability to obtain access to a circuit database or circuit design database.

HD can be expressed as a particular harmonic such as the first harmonic (HD1) or second harmonic (HD2), or as a total harmonic distortion (THD) which is a common measurement for the level of HD present in power systems. Some macro-modeling solutions provide universality and ease of use, but are inaccurate, with the HD result resulting in a D-S error that generally randomly floating within a range +/−20 dB or even worse, not within 1 dB or so desired by most circuit designers.

Disclosed embodiments include methods of HD macro-model error (or discrepancy) correction for electronic devices (e.g., integrated circuits (ICs) such as, amplifiers comparators, buffers or analog front ends) that feature a memory table-based method. A method of HD macro-model error correction uses a HD simulation macro-model for an electronic device and memory table having at least one row storing (i) an operating condition/variable (e.g., frequency) that affects HD and (ii) a HD coefficient. A processor runs the macro-model using information in the memory table for generating HD simulation values.

The memory table is initially filled with a first condition/variable and initial HD coefficient. The processor runs the simulation macro-model for generating an initial HD simulation value. An initial Datasheet to initial HD simulation error (initial D-S error) is determined. Provided the magnitude of D-S error is above a predetermined error bound (PEB) such as <1 dB, an updated HD coefficient(s) is used for repeating the filling, generating an updated HD simulation value and determining the D-S error until a corrected HD coefficient(s) is obtained which reduces the D-S error<the PEB. The corrected HD coefficient(s) is stored in the memory table to update the simulation macro-model. The initial HD coefficient(s) and coefficient adjustment can be automatically generated or can be entered manually by a user.

The condition/variable can comprise frequency, resistor (or impedance) loading, package parasitics, power supply or temperature, with the condition/variable generally spanning a range with each value of the condition/variable having an associated initial HD coefficient. Optionally there can be 2 or more conditions/variables in the memory table, such as frequency and loading, or the conditions/variables can be a compound condition/variable so that for example there is HD coefficient(s) associated with a frequency and a loading value. Disclosed methods can generally reduce the D-S error to <1 dB, provide universality, and ease-of-use.

### BRIEF DESCRIPTION OF THE DRAWINGS

Reference will now be made to the accompanying drawings, which are not necessarily drawn to scale, wherein:

FIG. 1 is a flow chart that shows steps in an example memory table-based method of HD macro-model error correction for electronic devices, according to an example embodiment.

FIG. 2 depicts an example system for implementing a disclosed memory table-based method of HD macro-model error correction for electronic devices, according to an example embodiment.

FIG. 3A is a plot of HD vs. frequency in dBc for an amplifier comparing the HD values from the Datasheet of the amplifier with HD values obtained from a known simulation. The D-S error can be seen to be about 8 dBc in the frequency range between 1 kHz and 100 kHz.

FIG. 3B is a plot of HD vs. frequency in dBc for the amplifier referred to in FIG. 3A comparing HD values from the Datasheet of the amplifier with HD values from a disclosed simulation using a disclosed memory table showing close HD value matching between the Datasheet and simulated values for HD2, with the D-S error shown being about 1 dBc or less in the frequency range between 1 kHz and 100 MHz.

### DETAILED DESCRIPTION

Example embodiments are described with reference to the drawings, wherein like reference numerals are used to designate similar or equivalent elements. Illustrated ordering of acts or events should not be considered as limiting, as some acts or events may occur in different order and/or concurrently with other acts or events. Furthermore, some illustrated acts or events may not be required to implement a methodology in accordance with this disclosure.

Also, the terms “coupled to” or “couples with” (and the like) as used herein without further qualification are intended to describe either an indirect or direct electrical connection. Thus, if a first device “couples” to a second device, that connection can be through a direct electrical connection where there are only parasitics in the pathway, or through an indirect electrical connection via intervening items including other devices and connections. For indirect coupling, the intervening item generally does not modify the information of a signal but may adjust its current level, voltage level, and/or power level.

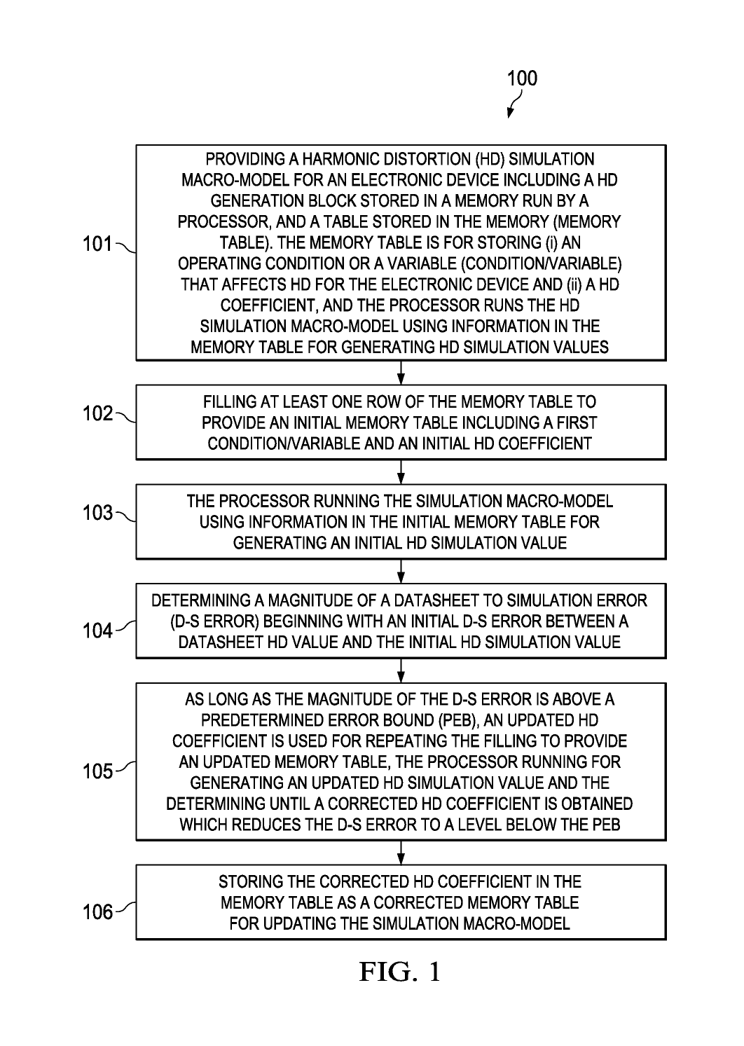

FIG. 1 is a flow chart that shows steps in an example memory table-based method 100 of HD macro-model error correction for electronic devices, according to an example embodiment. The electronic device can comprise a variety of integrate circuit (IC) types, such as an amplifier or a buffer, or any other electronic circuit type that can have a macro-model for the circuit generated which can generally be any electronic circuit.

Step 101 comprises providing a HD simulation macro-model for an electronic device including a HD generation block stored in a memory run by a processor (e.g., central processing unit (CPU), microcontroller unit (MCU) or digital signal processor (DSP)), and a table stored in the memory (memory table). The memory table has at least one row for storing (i) an operating condition or a variable (condition/variable) that affects HD for the electronic device and (ii) a HD coefficient. The processor is for running the HD simulation macro-model using information in the memory table for generating HD simulation values for the electronic device for predetermined set of operating conditions. The memory is generally a non-volatile memory.

Step 102 comprises filling at least one row of the memory table to provide an initial memory table including a first condition/variable and an initial HD coefficient. As noted above, the condition/variable can comprise frequency, resistor, impedance, loading, package parasitics associated with a particular package, such as a Small Outline Integrated Circuit (SOIC) or Power Small Outline Package (PSOP), power supply, or temperature, with the condition/variable generally spanning a range with each value of the condition/variable having an associated initial HD coefficient. As noted above, the condition/variable can also be a compound or nested variable including a plurality of variables, such as (HD vs. frequency) vs. loading) vs. power supply) vs. package type)).

Step 103 comprises the processor running the simulation macro-model using information in the initial memory table for generating an initial HD simulation value. Step 104 comprises determining a D-S error beginning with an initial D-S error between a Datasheet HD value and the initial HD simulation value.

In step 105 as long as the magnitude of the D-S error is above a predetermined error bound (PEB), an updated HD coefficient(s) is used for repeating the filling to provide an updated memory table, the processor running for generating an updated HD simulation value and the determining until a corrected HD coefficient(s) is obtained which reduces the D-S error to a level below the PEB. Step 106 comprises storing the corrected HD coefficient(s) in the memory table as a corrected memory table for updating the simulation macro-model.

Although steps 102, 104 and the updating of HD coefficients in step 105 of method 100 can optionally be performed manually, software is generally needed to run the simulation and to crunch hundreds if not thousands of data points to perform the curve fitting process to render the HD value(s) obtained from the simulation as close as possible to HD value(s) from the Datasheet.

Values for the initial HD coefficients can be determined automatically or the user can manually determine and fill both the condition(s)/variable(s) and the initial HD coefficient(s). For example, the user can manually “guess-calculate” or “guess-estimate” values for the initial HD coefficient(s).

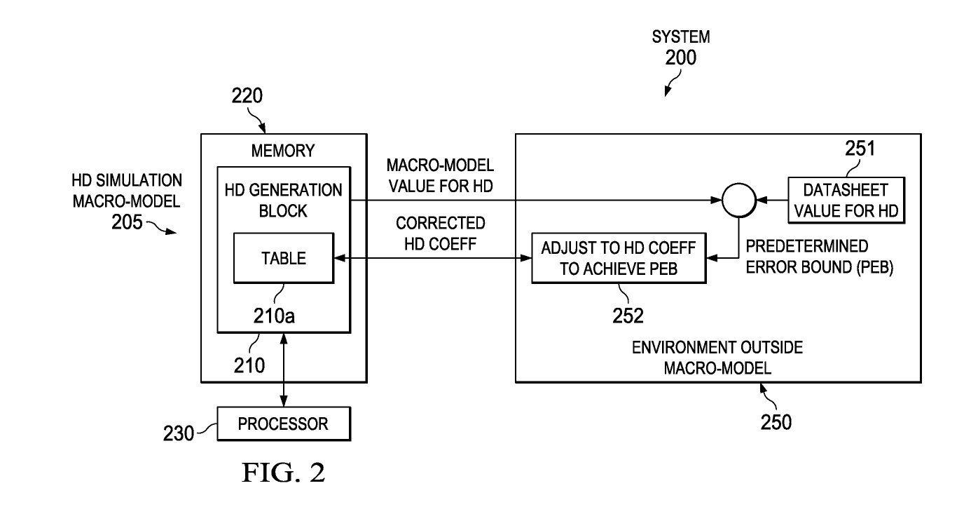

FIG. 2 depicts an example system 200 for implementing a disclosed memory table-based method of HD macro-model error correction for electronic devices, according to an example embodiment. System 200 includes a HD simulation macro-model 205 for an electronic device including a HD generation block 210 and memory table 210a stored in a memory 220 run by a processor 230. The memory table 210a is for storing (i) a condition/variable that affects HD for the electronic device and (ii) a HD coefficient(s), wherein the processor 230 runs the HD simulation macro-model 205 using information in the memory table 210a for generating simulated HD value(s).

System 200 also includes and environment located outside the HD simulation macro-model 250 that implements using a Datasheet value for HD from a datasheet file source 251 and the macro-model value for HD provided by the HD generation block 210 for determining a magnitude of the D-S error. As long as the magnitude of the D-S error is above a PEB, such as a PEB of 1 dB, the coefficient adjustment block shown as 252 iteratively adjusts the HD coefficient to achieve the PEB which when achieved reduces the D-S error below the PEB. Corrected HD coefficients shown output by block 252 are provided the memory table 210a for storing the corrected HD coefficients as a corrected memory table for updating the HD simulation macro-model 205. Although the determining of the magnitude of the D-S error, initial HD coefficient and coefficient adjustment shown in FIG. 2 are implemented by an environment outside the HD simulation macro-model 250, such as manually by a user working on a computer terminal remotely location relative to the HD simulation macro-model 205 (e.g., using communications over the Internet), as noted above each of those respective steps can be computer-implemented and thus automatically executed.

The user or software can also determine the updated coefficient values. One software based method for determining the updated coefficient values uses the Perturb and Observe (P&O) used in the solar industry. For a manual example, assume the predetermined HD level from a datasheet for the particular electronic device is −120 dBc, the PEB bound is 1 dBc, and the initial D-S error is 8 dBc. Manual iteration of the HD coefficients can be performed until the HD level reaches within a range from −119 dB to −121 dBc, which once reached becomes the corrected HD coefficient value(s).

Disclosed simulation macro-models including disclosed D-S error correction using a memory table may be provided to potential electronic circuit customers, such as on a company's Internet website. For example, for the Low Noise Quad Operational Amplifier LM837 provided by Texas Instruments Incorporated, one may access http://www.ti.com/lit/zip/snom476 which allows opening a .zip and open LM837.LIB. The code for this HD is embedded inside LM837.LIB text file. A user can implement disclosed simulation macro-models by using circuit schematic editor or by directly typing a circuit netlist, such as a PSPICE compatible netlist as shown on LM837.LIB inside http://www.ti.com/lit/zip/snom476.

As noted above, the memory table has condition(s)/variable(s) (e.g., frequency), that affects HD for the electronic device and (ii) HD coefficient(s). A generalized table representation for an example memory table method is shown below:

| Condition(s)/variable(s) | HD Coefficient |
|---|---|
| Condition/variable value #1 | CoeffValue#1 |
| Condition/variable value #2 | CoeffValue#2 |
| . | . |
| . | . |
| . | . |
| Condition/variable value #N | CoeffValue#N |

### EXAMPLES

Disclosed embodiments are further illustrated by the following specific Examples, which should not be construed as limiting the scope or content of this Disclosure in any way.

As noted above, the actual implementation of disclosed methods can be performed at the netlist level, or can be performed at the schematic level. This Example provides two specific netlist examples of detailed implementations with regard to disclosed memory table-based HD D-S error correction methods described for an amplifier with the condition/variable being signal frequency. In the original memory table shown below the condition/variable is signal frequency in a range between 1×10⁶ and 1×10⁹ Hz and the corresponding values for initial HD2 coefficients are as follows:

Original Memory Table:

| Frequency (Hz) | HD Coefficient |
|---|---|
| 1 × 10⁶ | 9000 |
| 1 × 10⁷ | 8000 |
| 1 × 10⁸ | 7000 |

### Example 1

A netlist example/detail implementation using the information in the above memory table is as follows:
.SUBCKT AMP 1 2 3 4 5
+PARAMS: FREQ=“USER INPUT POINTER=FREQUENCY VARIABLE”
The line immediately above is how a user CALLs the x-axis, in this example frequency as the condition/variable of the memory table.
ES1 S1 0 VALUE={IF ((FREQ<=1e6), 1, 0)}
ES2 S2 0 VALUE={IF ((FREQ>1e6) & (FREQ<=1e7), 1, 0)}
ES3A S3A 0 VALUE={IF ((FREQ>1e7) & (FREQ<=1e8), 1, 0)}
ES3B S3B 0 VALUE={IF ((FREQ>1e8), 1, 0)}
The ES1 to ES3B in the paragraph immediately above is how the condition/variable, in this case, the frequencies, are stored into the memory table in macromodel/pspice software language format.

| | |
|---|---|
| VCOEFF1 COEFF1 0 | 9000 |
| VCOEFF2 COEFF2 0 | 8000 |
| VCOEFF3A COEFF3A 0 | 7000 |
| VCOEFF3B COEFF3B 0 | 7000 |

The paragraph immediately above shows is how the HD coefficients are stored into the memory table in macromodel/pspice software language format
ETOTALCOEFF TOTALCOEFF 0 VALUE=
+{V(COEFF1)*V(S1)+V(COEFF2)*V(S2)
+V(COEFF3A)*V(S3A)+V(COEFF3B)*V(S3B)}
The paragraph immediately above is how one can implement the overall memory table by combining the left side of the memory table (the condition/variable) and the right side of the memory table (the HD Coefficient) in macromodel/pspice software language format.
X1 DISTORTION_CIRCUIT INPUT OUTPUT TOTALCOEFF

### Example 2

A Second netlist example/detail implementation is as follows:
.SUBCKT AMP 1 2 3 4 5
+PARAMS: FREQ=“USER INPUT POINTER=FREQUENCY VARIABLE”
.PARAM S1={IF((FREQ<=1e6), 1, 0)}
.PARAM S2={IF((FREQ>1e6) & (FREQ<=1e7), 1, 0)}
.PARAM S3A={IF((FREQ>1e7) & (FREQ<=1e8), 1, 0)}
.PARAM S3B={IF((FREQ>1e8), 1, 0)}
.PARAM COEFF1={9000}
.PARAM COEFF2={8000}
.PARAM COEFF3A={7000}
.PARAM COEFF3B={7000}
.PARAM TOTALCOEFF=
+{COEFF1*S1+COEFF2*S2
+COEFF3A*S3A+COEFF3B*S3B}
X1 DISTORTION_CIRCUIT INPUT OUTPUT
+PARAMS: TOTALCOEFF={TOTALCOEFF}

If one looks at the implementation closely, it can be seen that the first netlist (Example 1) uses “E” as the first letter of the paragraph that describes condition/variable within the memory table, uses “V” as the first letter of the paragraph that describes the HD coefficient within the memory table, and finally uses “E” as the first letter of the paragraph that forms the overall memory table). (The second netlist (Example 2) uses mostly “.PARAM” rather than “E” and “V”).

In macromodel/spice software/programming language the “E” and “V” are called as “voltage sources” while “.PARAM” is declaration of a variable/constant. Both methods either using “voltage sources” or “PARAM” can be used with disclosed embodiments.

Beyond the two netlist examples provided above, it is possible also to implement a disclosed memory table method above with various other implementations such as using multiplexer (MUX). The MUX can be implemented with NMOS of PMOS transistors acting as a switch. For example, to implement a disclosed HD memory table using a disclosed MUX, one can use the gate electrode of the MOS transistor for applying the HD variable/condition of the HD memory table+some storage component such as dc voltage source as the HD coefficient of the HD memory table applied to the source or drain (say the drain), with the output taken at the other of the source and drain (say the source).

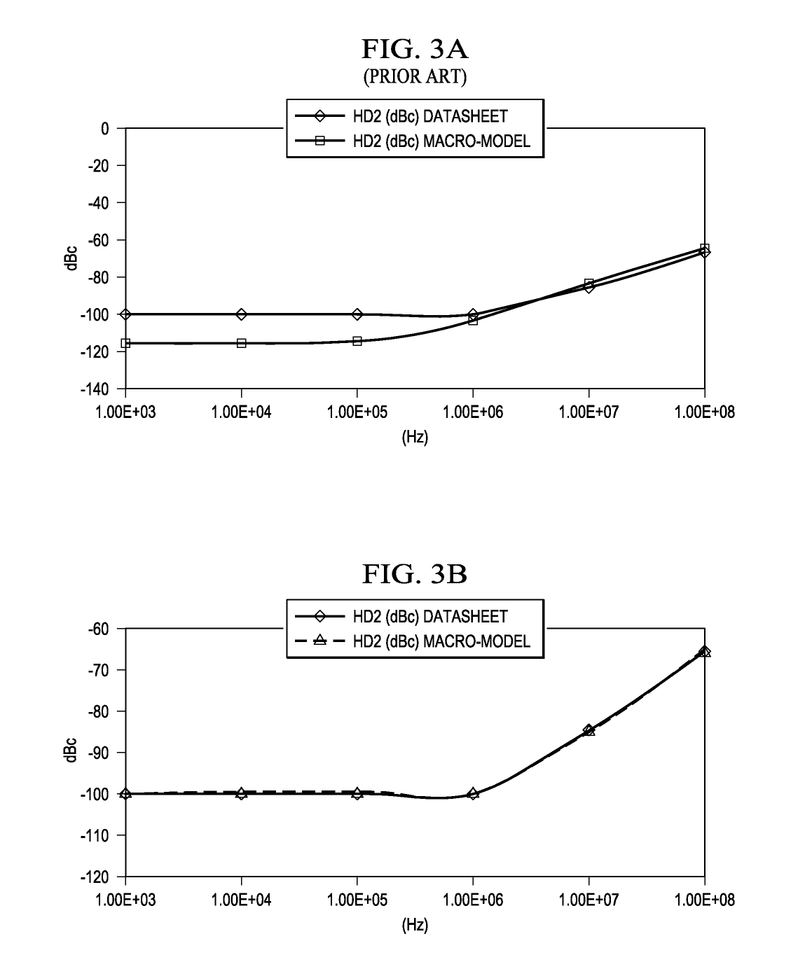

FIG. 3A is a plot of HD vs. frequency in dBc for an amplifier comparing the HD values from the Datasheet of the amplifier with HD values obtained from a known simulation program. The D-S Error can be seen to be about 8 dBc in the frequency range between 1 kHz and 100 kHz. FIG. 3B is a plot of HD vs. frequency in dBc for the amplifier referred to in FIG. 3A comparing HD values from the Datasheet of the amplifier with HD values from a disclosed simulation using a disclosed memory table showing close HD value matching between the Datasheet and simulated values for HD2, with the D-S error shown being about 1 dBc or less in the frequency range between 1 kHz and 100 MHz.

Since disclosed methods of HD macro-model error correction provide universality, ease-of-use, and accuracy, they are expected to attract customer usage because of the ability to replace the time the customers spent in the laboratory for HD related tedious setup and prototyping with faster cycle time by evaluating electronic devices with computer-aided tools in front of their computer. There is also expected to be enhancement in the knowledge base of sales individuals, as well as applications and system engineers because using disclosed methods they can learn and simulate HD at their computers rather than needing access to an expensive lab that requires comprehensive equipment related to HD applications.

Those skilled in the art to which this disclosure relates will appreciate that many other embodiments and variations of embodiments are possible within the scope of the claimed invention, and further additions, deletions, substitutions and modifications may be made to the described embodiments without departing from the scope of this disclosure.

1. A method of harmonic distortion (HD) macro-model error correction, comprising:
providing a HD simulation macro-model for an electronic device including a HD generation block stored in a memory run by a processor, and a table stored in said memory (memory table), wherein said memory table is for storing (i) an operating condition or a variable (condition/variable) that affects HD for said electronic device and (ii) a HD coefficient, wherein said processor is for running said simulation macro-model using information in said memory table for generating a HD simulation value;
filling at least one row of said memory table to provide an initial memory table including a first of said condition/variable (first condition/variable) and an initial of said HD coefficient (initial HD coefficient);
said processor running said simulation macro-model using information in said initial memory table for generating an initial HD simulation value;
determining a magnitude of a Datasheet to simulation error (D-S error) beginning with an initial D-S error between a Datasheet HD value and said initial HD simulation value;
as long as said magnitude of said D-S error is above a predetermined error bound (PEB), using an updated HD coefficient repeating said filling to provide an updated memory table, said processor running for generating an updated HD simulation value and said determining to obtain a corrected HD coefficient which reduces said D-S error below said PEB, and
storing said corrected HD coefficient in said memory table as a corrected memory table for updating said simulation macro-model.

2. The method of claim 1, wherein said condition/variable spans a range including at least a high value and a low value, and wherein said high value and said low value each include a corresponding respective one of said initial HD coefficients.

3. The method of claim 1, wherein said condition/variable is user selectable and includes at least one of frequency, output load, temperature, power supply, and package parasitics for said electronic device.

4. The method of claim 1, further comprising implementing said method using a circuit netlist for said electronic device for integrating said information in said memory table into said simulation macro-model.

5. The method of claim 4, further comprising implementing said simulation macro-model using a circuit schematic editor or by directly typing to said circuit netlist.

6. The method of claim 2, wherein said condition/variable comprises a compound or nested condition/variable including a plurality of said conditions/variables.

7. The method of claim 1, wherein said electronic device comprises an amplifier, comparator, a buffer or an analog front end.

8. A computer program product, comprising:
a non-transitory data storage medium (memory table) that includes program instructions for a processor to execute a method of harmonic distortion (HD) macro-model error correction, said computer program product comprising:
code for implementing a HD simulation macro-model for an electronic device including a HD generation block stored run by said processor, and for providing a table in said memory table, wherein said memory table is for storing at least one row of (i) an operating condition or a variable (condition/variable) that affects HD for said electronic device and (ii) a HD coefficient, wherein said processor is for running said simulation macro-model using information in said memory table for generating a HD simulation value;
code for said processor running said simulation macro-model using information in an initial memory table including a first of said condition/variable (first condition/variable) and an initial of said HD coefficient (initial HD coefficient) for generating at least an initial HD simulation value;
code for determining a magnitude of a Datasheet to simulation error (D-S error) beginning with an initial D-S error between a Datasheet HD value and said initial HD simulation value, and
code for storing an updated HD coefficient as a corrected HD coefficient in said memory table as a corrected memory table for updating said simulation macro-model.

9. The computer program product of claim 8, further comprising:
code for filling said row of said memory table to provide said initial memory table, and
code for as long as said magnitude of said D-S error is above a predetermined error bound (PEB), iteratively generating said updated HD coefficient repeating said filling to provide an updated memory table, said processor running for generating an updated HD simulation value and said determining to obtain said corrected HD coefficient which reduces said D-S error below said PEB.

10. The computer program product of claim 8, wherein said condition/variable spans a range including at least a high value and a low value, and said high value and said low value each include a corresponding respective one of said initial HD coefficient.

11. The computer program product of claim 8, wherein said condition/variable is user selectable and includes at least one of frequency, output load, temperature, power supply, and a package for said electronic device.

12. The computer program product of claim 8, wherein said condition/variable comprises a compound or nested condition/variable including a plurality of said conditions/variables.

13. The computer program product of claim 8, wherein said electronic device comprises an amplifier, a buffer, or an analog front end.
